(19) United States
(12) Patent Application Publication
(10) Pub. No.: US 2005/0060569 A1
(43) Pub. Date: Mar. 17, 2005

(54) Method of managing the information on the release of restriction on use

(75) Inventors: Ryuji Uesugi, Tokyo (JP); Tsuyoshi Haraguchi, Tokyo (JP); Shunichi Kase, Tokyo (JP); Hideaki Yamamoto, Tokyo (JP); Toshiyuki Kikuchi, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Photo Imaging, Inc., Tokyo (JP)

(21) Appl. No.: 10/934,283

(22) Filed: Sep. 3, 2004

(30) Foreign Application Priority Data
Sep. 12, 2003 (JP) JP2003-321735
Sep. 22, 2003 (JP) JP2003-330789

(51) Int. Cl. H04L 9/00

(52) U.S. Cl. 713/200

(57) ABSTRACT

There is described a method of managing information on the release of restriction on use that permits license management even where linkage of a hardware key is limited, without sacrificing the user work efficiency. The method for controlling a release information set for releasing a function from an application disabled status thereof, includes the steps of: instructing an operation for transferring the release information set from a first storage section, in which release information sets corresponding to the plurality of functions are stored, to a second storage section by selecting one of the plurality of functions provided in the apparatus; specifying the release information set to be transferred as instructed in the instructing step; reading out the release information set, specified in the specifying step, from the first storage section; storing the release information set, read in the reading step, in the second storage section.

### BACKGROUND OF THE INVENTION

The present invention relates to a method of managing the information on the release of restriction on use, particularly to a method of managing the information on the release of restriction on use that permits license management even where linkage of a hardware key is limited, without sacrificing the user work efficiency.

Attempts have been made to provide license management by installing software in various types of hardware apparatuses including a personal computer, and restricting the use of the software that controls the operation of such hardware apparatuses.

Since software can be copied with comparative ease, its license management is not easy. At present, the following three methods are used to provide license management:

One of these license management methods is to require a password to be inputted when installing software. A second method is to use the product number (serial number) assigned to each of the hardware apparatuses to restrict the installation or un-installation of software (described in Patent Document 1). In a third method, information required for installation or un-installation (hereinafter referred to as “release information”) is locked on an external device such as a dongle (hereinafter referred to as “hardware key” in this Specification), and this hardware key is used to restrict installation or un-installation (described Patent Document 2).

When the hardware key is used for software license management, as in the third method described above, a great number of hardware keys will be required if there are many software items to be managed. This will require use of a hardware key capable of locking a plurality of release information items. However, where there are only two interfaces for connection with the hardware key, it is impossible to perform software operation using all the release information items locked simultaneously on three hardware keys. This arrangement has required a troublesome job of replacing hardware keys in the prior art.

The software that controls the operation of various kinds of devices including a personal computer to perform specific functions tends to be easily produced and used without license, by its very nature. In recent years, effects have been made on an extensive scale to promote technological development of license management method to protect against illegal use of software.

For example, a manufacturing number and a password are assigned to each of the recording media such as CD-ROM loaded with software. A check is made to see whether or not they have been correctly inputted at the time of installation, and installation is allowed only when they have been correctly inputted.

These methods, however, fail to provide an effective solution to the problem, because, if a combination of the manufacturing number and password is revealed to another user, the software can be easily used.

To solve the problem, the Patent Document 1 proposes a technique, wherein users are supplied in advance with such a recording medium as a CD-ROM with software loaded therein, and a dongle and a medium called a “chip” corresponding to the software of that recording medium are used to license installation of this software; alternatively, the Internet is employed to license installation of this software. According to this method, installation of software is licensed with reference to the identification number assigned to each dongle and the identification number such as what is called “Mac address” assigned to a computer. Thus, the software under license can be installed only on the computer connected to the licensed dongle or licensed computer.

According to the method described in Patent Document 1, however, the software under license can be installed only on the computer connected to the licensed dongle or licensed computer. If the software is to be used on another computer, for example, due to a trouble of the computer, it cannot be installed although the license has already been granted, with the result that the software cannot be utilized.
[Patent Document 1] Official Gazette of Japanese Patent Tokkai 2002-108482

### SUMMARY OF THE INVENTION

To overcome the abovementioned drawbacks in conventional methods and apparatus, the first object of the present invention is to provide a method of managing the information on the release of restriction on use (hereinafter, also referred to as a release information), capable of license management without sacrificing the operation efficiency of a user, even if the connection of a hardware key is restricted.

Further, the second object of the present invention is to provide a license management system, a license management method and a license management recording medium that ensure a correct license management, without the trouble of software being disabled although the license has already been granted.

Accordingly, to overcome the cited shortcomings, the abovementioned object of the present invention can be attained by methods and systems described as follow.

(1) A method for controlling a release information set for releasing a function, which is one of a plurality of functions provided in an apparatus, from an application disabled status thereof, comprising the steps of: instructing an operation for transferring the release information set from a first storage section, in which release information sets corresponding to the plurality of functions are stored, to a second storage section by selecting one of the plurality of functions provided in the apparatus; specifying the release information set to be transferred as instructed in the instructing step; reading out the release information set, specified in the specifying step, from the first storage section; storing the release information set, read in the reading step, in the second storage section.

(2) The method of item 1, further comprising the step of; displaying the function, being one of the plurality of functions provided in the apparatus, on a display section, so that the operation for transferring the release information set from the first storage section to the second storage section can be instructed by using the display device in the instructing step.

(3) The method of item 1, wherein the reading step includes the step of: dividing the release information set into divided release information sets; and reading out the divided release information sets.

(4) The method of item 1, wherein the reading step includes the step of: deleting the release information set from a storage section from which the release information set was previously read.

(5) The method of item 1, wherein, in the specifying step, another release information set for releasing another function, which interlocks the function selected in the instructing step, is also specified as a function to be transferred as instructed in the instructing step.

(6) The method of item 2, further comprising the steps of: detecting any one of the first storage section, the second storage section and another storage section; and determining whether or not a function, with respect to a release information set stored in a storage section detected in the detecting step, is displayed on the display section.

(7) The method of item 2, further comprising the step of: determining whether or not at least one of creating dates of the first storage section, the second storage section and another storage section, serial numbers thereof, a version number of the function and a transferred/edited date of the release information, is displayed on the display section in addition to the function.

(8) The method of item 1, further comprising the step of: inputting a first password owned by a user; acquiring a second password allotted to a hardware-key; and allowing the hardware-key to conduct a readout operation to be performed in the reading step, only when the first password coincides with the second password.

(9) The method of item 1, wherein a hardware-key is employed as the first storage section and/or the second storage section.

(10) A method for controlling a release information set for releasing a function, which is one of a plurality of functions provided in an apparatus, from an application disabled status thereof, comprising the steps of: instructing an operation for transferring the release information set from a first storage section, in which release information sets corresponding to the plurality of functions are stored, to a second storage section by selecting one of the plurality of functions provided in the apparatus; specifying the release information set to be transferred as instructed in the instructing step; reading out a first release-information set and a second release-information set from the first storage section and the second storage section, respectively; generating an added release-information set by adding the release-information set, specified in the specifying step, to the second release-information set read from the second storage section; generating a deleted release-information set by deleting the release-information set, specified in the specifying step, from the first release-information set; storing the added release-information set, generated in the first generating step, in the second storage section; and storing the deleted release-information set, generated in the second generating step, in the first storage section.

(11) The method of item 10, further comprising the step of; displaying the function, being one of the plurality of functions provided in the apparatus, on a display section, so that the operation for transferring the release information set from the first storage section to the second storage section can be instructed by using the display device in the instructing step.

(12) The method of item 10, wherein the reading step includes the step of: dividing the release information set into divided release information sets; and reading out the divided release information sets.

(13) The method of item 10, wherein the reading step includes the step of: deleting the release information set from a storage section from which the release information set was previously read.

(14) The method of item 13, wherein the step of storing the added release-information set and the step of storing the deleted release-information set are performed after the step of deleting the release information set is completed.

(15) The method of item 10, wherein, in the specifying step, another release information set for releasing another function, which interlocks the function selected in the instructing step, is also specified as a function to be transferred as instructed in the instructing step.

(16) The method of item 11, further comprising the steps of: detecting any one of the first storage section, the second storage section and another storage section; and determining whether or not a function, with respect to a release information set stored in a storage section detected in the detecting step, is displayed on the display section.

(17) The method of item 11, further comprising the step of: determining whether or not at least one of creating dates of the first storage section, the second storage section and another storage section, serial numbers thereof, a version number of the function and a transferred/edited date of the release information, is displayed on the display section in addition to the function.

(18) The method of item 10, further comprising the step of: inputting a first password owned by a user; acquiring a second password allotted to a hardware-key; and allowing the hardware-key to conduct a readout operation to be performed in the reading step, only when the first password coincides with the second password.

(19) The method of item 10, wherein a hardware-key is employed as the first storage section and/or the second storage section.

(20) A method for controlling a release information set for releasing a function, which is one of a plurality of functions provided in an apparatus, from an application disabled status thereof, comprising the steps of: instructing an operation for transferring the release information set from a first storage section, in which release information sets corresponding to the plurality of functions are stored, to a second storage section by selecting one of the plurality of functions provided in the apparatus; specifying the release information set to be transferred as instructed in the instructing step; reading out a first release-information set and a second release-information set from the first storage section and the second storage section, respectively; generating an added release-information set by adding the release-information set, specified in the specifying step, to the second release-information set read from the second storage section; generating a deleted release-information set by deleting the release-information set, specified in the specifying step, from the first release-information set; storing the added release-information set, generated in the first generating step, in the second storage section; and storing the first release-information set, read in the reading step, in the first storage section.

(21) The method of item 20, further comprising the step of; displaying the function, being one of the plurality of functions provided in the apparatus, on a display section, so that the operation for transferring the release information set from the first storage section to the second storage section can be instructed by using the display device in the instructing step.

(22) The method of item 20, wherein the reading step includes the step of: dividing the release information set into divided release information sets; and reading out the divided release information sets.

(23) The method of item 20, wherein the reading step includes the step of: deleting the release information set from a storage section from which the release information set was previously read.

(24) The method of item 23, wherein the step of storing the added release-information set and the step of storing the deleted release-information set are performed after the step of deleting the release information set is completed.

(25) The method of item 20, wherein, in the specifying step, another release information set for releasing another function, which interlocks the function selected in the instructing step, is also specified as a function to be transferred as instructed in the instructing step.

(26) The method of item 21, further comprising the steps of: detecting any one of the first storage section, the second storage section and another storage section; and determining whether or not a function, with respect to a release information set stored in a storage section detected in the detecting step, is displayed on the display section.

(27) The method of item 21, further comprising the step of: determining whether or not at least one of creating dates of the first storage section, the second storage section and another storage section, serial numbers thereof, a version number of the function and a transferred/edited date of the release information, is displayed on the display section in addition to the function.

(28) The method of item 20, further comprising the step of: inputting a first password owned by a user; acquiring a second password allotted to a hardware-key; and allowing the hardware-key to conduct a readout operation to be performed in the reading step, only when the first password coincides with the second password.

(29) The method of item 20, wherein a hardware-key is employed as the first storage section and/or the second storage section.

(30) A system for controlling a licensing operation of a program, comprising: a program storing section to store the program; a license-information acquiring section to acquire license information, which represent an enabled or disabled status in respect to an execution of the program; a determining section to determine whether or not the program is allowed to execute, based on the license information acquired by the license-information acquiring section; and a program executing section to execute the program only when the determining section determines that the program is allowed to execute.

(31) The system of item 30, wherein the license information includes usable time information, and the determining section determines that the program is allowed to execute, when a usable time period represented by the usable time information exceeds a prescribed time period.

(32) The system of item 30, wherein the license information includes usable number information, which represent a usable number of times of executing the program, and the determining section determines that the program is allowed to execute, when the usable number of times represented by the usable number is other than zero.

(33) The system of item 30, further comprising: a license-information changing section to change a content of the license information.

(34) The system of item 33, wherein the license-information changing section changes usable time information included in the license information before the determining section determines whether or not the program is allowed to execute.

(35) The system of item 33, wherein the license-information. changing section changes usable number information, which represent a usable number of times of executing the program and are included in the license information, before the determining section determines whether or not the program is allowed to execute.

(36) The system of item 30, wherein the license-information acquiring section acquires the license information by reading the license information stored in a storage medium.

(37) The system of item 30, wherein the license-information acquiring section acquires the license information through a communication line.

(38) A method for controlling a licensing operation of a program, comprising the steps of: storing the program in a program storing section; acquiring license information, which represent an enabled or disabled status in respect to an execution of the program; determining whether or not the program is allowed to execute, based on the license information acquired in the acquiring step; executing the program only when it is determined in the determining step that the program is allowed to execute.

(39) The method of item 38, wherein the license information includes usable time information, and it is determined in the determining step that the program is allowed to execute, when a usable time period represented by the usable time information exceeds a prescribed time period.

(40) The method of item 38, wherein the license information includes usable number information, which represent a usable number of times of executing the program, and it is determined in the determining step that the program is allowed to execute, when the usable number of times represented by the usable number is other than zero.

(41) The method of item 38, further comprising the step of: changing a content of the license information.

(42) The method of item 41, wherein usable time information included in the license information are changed before it is determined in the determining step whether or not the program is allowed to execute.

(43) The method of item 41, wherein usable number information, which represent a usable number of times of executing the program and are included in the license information, are changed before the determining section determines whether or not the program is allowed to execute.

(44) The method of item 38, wherein the license information are acquired by reading the license information stored in a storage medium.

(45) The method of item 38, wherein the license information are acquired through a communication line.

(46) A storage medium linkable to a system for controlling a licensing operation of a program, comprising: license information, which represent an enabled or disabled status in respect to an execution of the program; wherein the system includes: a program storing section to store the program; a license-information acquiring section to acquire the license information, which represent an enabled or disabled status in respect to an execution of the program; a determining section to determine whether or not the program is allowed to execute, based on the license information acquired by the license-information acquiring section; and a program executing section to execute the program only when the determining section determines that the program is allowed to execute.

### BRIEF DESCRIPTION OF THE DRAWINGS

Other objects and advantages of the present invention will become apparent upon reading the following detailed description and upon reference to the drawings in which:

FIG. 1 is a block diagram representing a first embodiment of a license management system for implementing a method of managing the information on the release of restriction on use according to the present invention;

FIG. 2 is a processing flowchart representing an example of method of managing the information on the release of restriction on use, as the first embodiment;

FIG. 3 is a functional block diagram representing a second embodiment of the method of managing the information on the release of restriction on use according to the present invention;

FIG. 4 is a processing flowchart representing an example of a method of managing the information on the release of restriction on use, as the second embodiment;

FIG. 5 is a functional block diagram representing a third embodiment of method of managing the information on the release of restriction on use according to the present invention;

FIG. 6 is a processing flowchart representing an example of a method of managing the information on the release of restriction on use, as the third embodiment;

FIG. 7 is a diagram showing an example of image display in the processing by a method of managing the information on the release of restriction on use according to the present invention;

FIG. 8 is a diagram showing an example of image display in the processing by a method of managing the information on the release of restriction on use according to the present invention;

FIG. 9 is a diagram showing an example of image display in the processing by a method of managing the information on the release of restriction on use according to the present invention;

FIG. 10 is a diagram showing an example of image display in the processing by a method of managing the information on the release of restriction on use according to the present invention;

FIG. 11 is a diagram showing an example of image display in the processing by a method of managing the information on the release of restriction on use according to the present invention;

FIG. 12 is a diagram representing the schematic configuration of the license management system for implementing the license management method of the present invention;

FIG. 13 is a block diagram representing a computer 100 used in the license management system;

FIG. 14 is a diagram showing an example of recording execution enable/disable information in the present invention;

FIG. 15 is a diagram showing another example of recording execution enable/disable information in the present invention;

FIG. 16 is a diagram showing an example of the flow of processing in the license management method to be processed by the license management system; and

FIG. 17 is a diagram showing an example of the flow of processing when the license is updated in the license management method to be processed by the license management system.

### DETAILED DESCRIPTION OF THE PREFERRED EMBODIMENT

Referring to the drawings, the following describes the preferred embodiments of the present invention:

The method of managing the information on the release of restriction on use according to the present invention is implemented by installing a program on a hardware apparatus such as a computer wherein the hardware apparatus applies the processing to be described later. The following describes the method of managing the information on the release of restriction on use according to the present invention with reference to a computer used as a hardware apparatus for implementing the method.

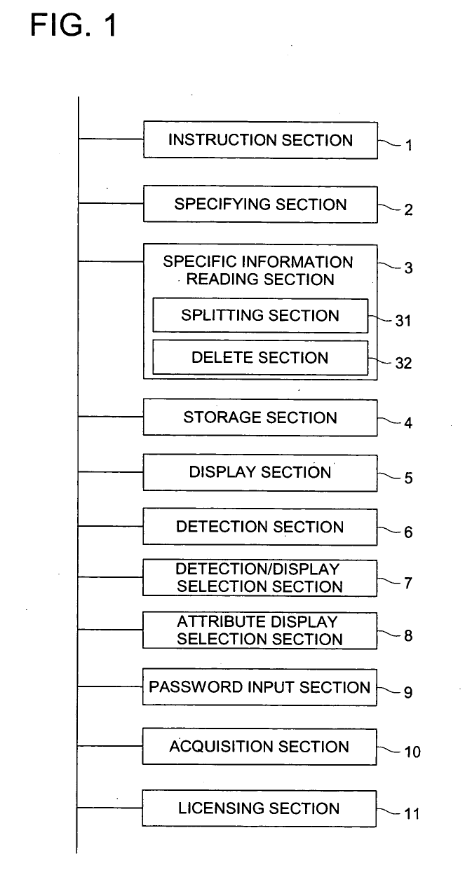

FIG. 1 is a block diagram representing a first embodiment of a license management system for implementing a method of managing the information-on the release of restriction on use according to the present invention. In FIG. 1, numeral 1 denotes an instruction section for implementing an instruction process, 2 a specifying section for implementing a specifying process, 3 a specific information reading section for implementing a specific information reading process, and 4 a storage section for implementing a storage process.

The license management system of the present invention is preferably composed of a display section 5 for implementing a display process, a detection section 6 for implementing detection process, a detection/display selection section 7 for implementing a detection/display selection process, an attribute display selection section 8 for implementing an attribute display selection process, a password input section 9 for implementing a password input process, an acquisition section 10 for implementing an acquisition process and an licensing section 11 for implementing a licensing process.

The license management system of the present invention is controlled by the control section (not illustrated) to perform the operations to be described later.

In the present Specification, the identification information storage section at the source of function movement, included in the identification information storage section, is referred to as a first identification information storage section, and the identification information storage section at the destination of function movement is referred to as a second identification information storage section. In the present invention, a hardware key is preferred to be used as an identification information storage section. However, without being restricted thereto, various types of recording media such as a CD-R and flexible disk can be used.

In the instruction section 1, the instruction for movement is given by selecting the function applied to the release information that moves from the first identification information storage section storing the release information for releasing the restriction on using the functions of the apparatus having a plurality of functions, to the second identification information storage section. This instruction for movement is given upon reception of an input by the user employing such an inputting apparatus as a mouse and keyboard. In this case, an indication section is preferred to be arranged in such a way that the function applied to the release information stored in the first identification information storage section is displayed so as to be moved by the instruction section 1. Display on the display section is provided by a CRT monitor, liquid crystal monitor or similar display apparatus. The release information is displayed by the display section 5 so that movement can be performed by checking the display. This arrangement clearly defines the work procedure and ensures easy movement and editing of the function without the possibility of damaging the setting information due to a failure of setting the set information.

A plurality of functions are preferred to include an optional function, maintenance function and performance adjusting function.

The optional function provides value-added functions, in addition to the standard function of the operation system. For example, the optional function of a certain image processing apparatus includes the Digital ICE, CD-R burning and red-eye correction functions. The Digital ICE function provides a function of handling the noise components of the captured image, the CD-R burning function stores the captured image on a CD-R, and the red-eye correction function corrects the red-eye of the person in the captured image.

A desired optional function can be operated by changing the combination of the identification information storage sections storing the information on the release of restriction on use of the aforementioned optional function. In a system where a restriction is imposed on the number of the combinations of identification information storage sections due to the nature of the operation system, a system operation of higher work efficiency can be provided by the method of managing the information on the release of restriction, according to the present claim.

The maintenance function adjusts various devices. For example, when a failure has occurred to the image-capturing section of the image processing system and this image-capturing section must be replaced, the parameters inherent to the captured-image device must be adjusted for each operation system. The aforementioned parameter adjusting function provides a maintenance function involving restrictions on use.

The identification information storage section recording the information on the release of restriction on use of the maintenance function can be incorporated in the operation system. After adjustment, however, verification of the operation must be performed on the operation system in many cases.

The aforementioned maintenance function can be operated by changing the combination between the identification information storage section storing the information on the release of restriction on use of the maintenance function and the identification information storage section incorporated in the operation system. However, in a system where a restriction is imposed on the number of the combinations of identification information storage sections due to the nature of the operation system, maintenance work can be performed by the method of managing the information on the release of restriction, according to the present claim, without sacrificing the maintenance efficiency.

After maintenance work is over, if release information on the aforementioned maintenance function is returned to the identification information storage section carried by the maintenance personnel, the operation system can easily be set back to the state prior to maintenance. Further, the maintenance personnel need not carry a parameter adjusting tool.

The performance adjusting function adjusts the capacities of various functions. For example, when an image processing system is manufactured as a serialized product, the added value of the product is generally classified into a “function” and “throughput”. In the prior art, the throughput can be implemented by changing the software corresponding to each device. However, a greater development efficiency can be ensured by using the performance control parameter and switching the corresponding control parameters and software processing by the same software. This also ensures more stable individual product quality.

The aforementioned performance control parameters includes a control parameter for capturing a transparent document such as a film or a reflective document applied to the apparatus, a control parameter for conveying the aforementioned film and reflective document or scanning the image-capturing apparatus, a control parameter for exposure to a photosensitive material, a control parameter for conveying the photosensitive material, and image quality parameter related to image processing.

If throughputs are provided in several levels and are made to conform to the information on the release of restriction on use, an intended product can be manufactured merely by storing the relevant release information in the identification information storage section.

Release information can be defined as the information consisting of table data including a flag of 2 bits or more for each function. It is possible to store release information regarding the restriction on the use of a plurality of functions. In addition to the release information regarding the restriction on the use of the relevant function, the flag can contain the information that distinguishes between the release information stored in the initial stage of creating the information, the additional release information stored from the second identification information storage section, and the deletion release information.

The specifying section 2 specifies the release information applied to the instruction for movement given by the instruction section 1. Since the release information applied to instruction for movement is given by the specifying section 2, a user can select the release information that moves from the first identification information storage section to the second identification information storage section, merely by selecting the function at the instruction section 1. As described above, release information linked with the function can be specified as the release information applied to the instruction for movement by the specifying section 2.

It is preferred that the release information for releasing the restriction on the use of the function interlocked with the function selected together with the release information for releasing the restriction of use of the aforementioned selected function be specified as release information applied to the instruction for movement by the specifying section 2.

The interlocked function includes, for example, the function A related to image processing. A license is granted with reference to this function A. This function that is normally carried out with a certain level of throughput maintained. Further, the function B adjusts the throughput of the function A.

When the interlocked function is specified as the release information applied to the instruction for movement, it is possible to adopt the sequential procedure wherein the function A is moved and edited, and then the function B is moved and edited. It is also possible to arrange such a configuration that, if the function B is moved and edited, the function A is also moved and edited. This configuration simplifies the move/edit procedure and avoids an error in the move/edit procedure.

The specific information reading section 3 scans the release information specified by the specifying section 2 from the first identification information storage section.

The specific information reading section 3 is preferred to have a splitting section 31 for implementing the splitting process of splitting the release information to be scanned. When the release information is composed of eight bits, for example, it is split into two bits by the splitting section 31.

The specific information reading section 3 is preferred to have a delete section 32 for implementing the delete process of deleting the release information having been scanned, from the identification information storage section of the source of scanning from which the release information is scanned. The storage section 4 is preferred to store the release information, which has been deleted by the delete section 32.

Since the release information is split and scanned and the scanned release information is deleted, there is no concern about the possible copying of the entire release information.

The storage section 4 stores the release information scanned by the specific information reading section 3, into the second identification information storage section.

The display section 5 displays the function applied to the release information stored in the first identification information storage section so as to be moved in the instruction process.

The detection section 6 checks if any one of the first identification information storage section, second identification information storage section and other identification information storage section is connected or not.

The detection/display selection section 7 receives the selection as to whether or not the function applied to the release information stored in the identification information storage section detected by the detection section 6 should be displayed on the display section 5. When the detection/display selection section 7 is utilized, there is only the display of the function of the identification information storage section applied to the instruction for movement in the instruction section 1, from the connected identification information storage section. This arrangement allows the user to verify only the required information.

If the detection section 6 and detection/display selection section 7 are provided, it is possible to easily verify the function available to the detected identification information storage section, without using any special software.

In addition to the function stored in the identification information storage section, the attribute display selection section 8 has the function of receiving the selection as to whether or not at least one of the date of creating the identification information storage section, serial number, version number of the aforementioned function and the date of moving and editing the release information is displayed on the display section 5.

The date of creation refers to the date on which the identification information storage section is created. If the date of creation is displayed, whether the release information is created or not can be managed according to the date of creating the identification information storage section.

The serial number is assigned to each of the identification information storage sections. If the serial number is displayed, each identification information storage section can be distinguished, and an identification information storage section in charge of the current operation can be placed under management.

The version number of the aforementioned number denotes the number of the version of the software for implementing this function. When one and the same function has a plurality of versions they can be identified by displaying the version number.

The date of moving and editing the release information is the date when the release information of the identification information storage section is stored. When the date of moving and editing the release information is displayed, both the release information and the date of moving and editing can be verified simultaneously at the time of moving and editing; thus updating of the release information can be confirmed with great ease and a high degree of reliability.

A licensing section 11 checks the identity between the password inputted by the user from the password input section 9 and the password of the identification information storage section acquired by the acquisition section 10. Only when they are identical with each other, a license is granted to the identification information storage section to scan the information using the specific information reading section 3.

The aforementioned licensing section 11 allows the password to manage the release information of the identification information storage section. For example, release information management can be performed by assigning different passwords to the identification information storage sections of different manufacturers.

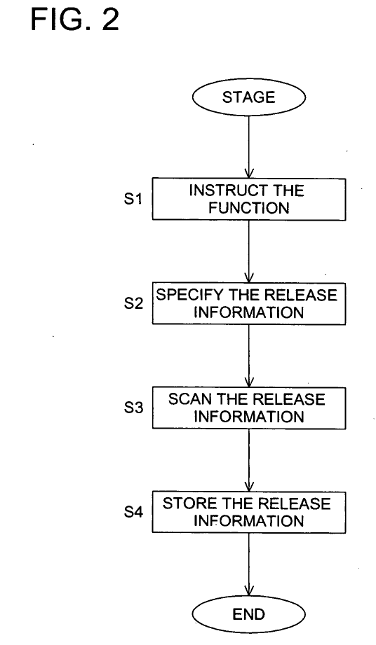

Referring to FIG. 2, the following describes the operation of the aforementioned license management system:

FIG. 2 is a processing flowchart representing the method of managing the information on the release of restriction on use, as the first embodiment.

When the instruction section 1 (the reference numerals hereinafter as shown in FIG. 1) has received the input of the instruction for movement (Step S1), the release information applied to the instruction for movement is specified by the specifying section 2 (Step S2). The user can input the instruction for movement from the instruction section 1, by selecting the function applied to the release information that moves to the second identification information storage section, from the function applied to one, two or more release information items.

When the release information applied to the instruction for movement is specified, the specified release information is read from the first identification information storage section by the specific information reading section 3 (Step S3). It is preferred that reading in Step S3 be carried out after the release information has been split. It is also preferred that the release information having been read be deleted from the identification information storage section of the source from which it has been read. However, when a failure has occurred to the reading by the specific information reading section 3, this deletion should not be performed.

The release information read out by the specific information reading section 3 is stored into the second identification information storage section by the storage section 4 (Step S4).

According to the method of managing the information on the release of restriction of the present invention, the release information of the function selected by the system having a plurality of functions is moved to an identification information storage section and is edited there, and the release information is placed under collective management. Thus, the user using the system can utilize the system without sacrificing the work efficiency, even when the connection of the identification information storage section is limited.

Since only the release information of the required function is moved, the time required for movement and editing can be reduced.

Since the addition, selection and switching of the function can be managed by the minimum number of the identification information storage sections, the apparatus variations can be increased.

After the setting information of the identification information storage section has been moved and edited, the identification information storage section without release information is recovered, and the manufacturer adds new release information to it and puts it on the market. This arrangement allows the identification information storage section to be reused repeatedly and hence the cost is reduced, and resources can be saved.

The following describes the second embodiment of the method of managing the information on the release of restriction according to the present invention:

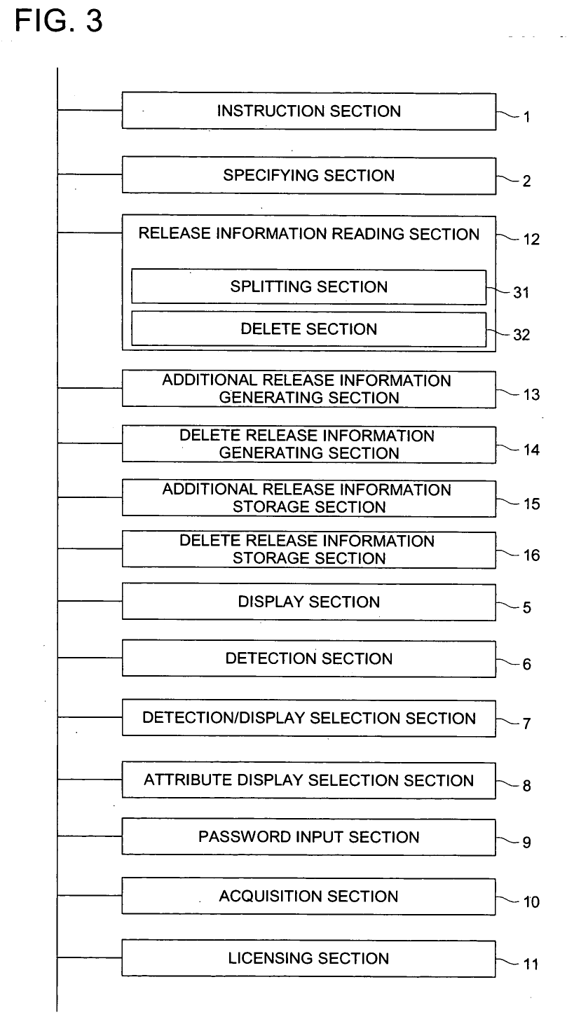

FIG. 3 is a functional block diagram representing a second embodiment of the method of managing the information on the release of restriction on use according to the present invention.

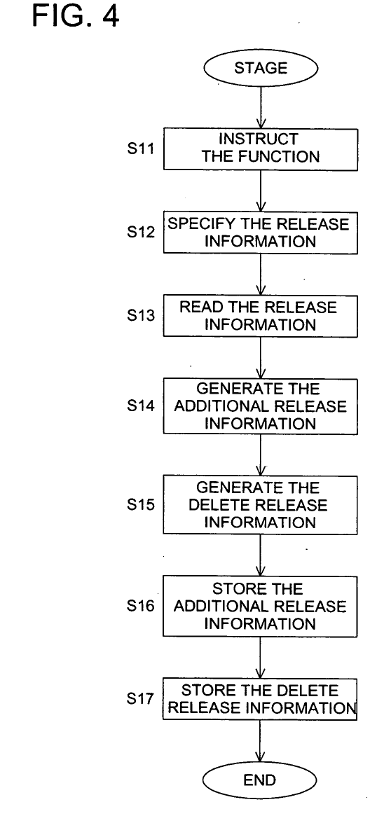

FIG. 4 is a processing flowchart representing a method of managing the information on the release of restriction on use, as the second embodiment.

In FIG. 3, the same reference numerals as those of FIG. 1 denote the same configuration, unless otherwise specified, and their description will be omitted to avoid duplication.

In FIG. 3, numeral 12 denotes a release information reading section, 13 an additional release information generating section, 14 a delete release information generating section, 15 an additional release information storage section, and 16 a delete release information storage section.

The release information reading section 12 reads the release information from the first and second identification information storage sections. The release information is read in the same manner as that of the first embodiment.

The additional release information generating section 13 acquires the delete information specified by the specifying section 2, from the release information read from the first identification information storage section, and adds the acquired delete information to the release information read from the second identification information storage section, whereby the additional release information is generated.

The delete release information generating section 14 deletes the delete information specified by the specifying section 2, from the release information read from the first identification information storage section, whereby the delete release information is generated.

The generated additional release information is stored in the second identification information storage section by the additional release information storage section 15. The delete release information is stored in the first identification information storage section by the delete release information storage section 16.

Referring to FIG. 4, the following describes the flow of processing: When the instruction for movement is given by the instruction section 1 (Step S11), the release information is specified by the specifying section 2 (Step S12).

The release information is read from the first identification information storage section and second identification information storage section by the release information reading section 12 (Step S13), and the additional release information is generated by the additional release information generating section 13 from the read release information (Step S14). Then the delete release information is generated by the delete release information generating section 14 (Step S15).

The generated additional release information is stored in the second identification information storage section by the additional release information storage section 15. The delete release information is stored in the first identification information storage section by the delete release information storage section 16 (Step S17).

As described above, the method of managing the information on the release of restriction according to the present embodiment reads both the release information on the source for movement and that on the destination for movement. It generates the additional release information obtained by adding the release information to be moved, to the release information at the destination from the read release information, and the delete release information obtained by deleting the release information to be moved, from the release information at the source of movement, and stores each of them.

According to the method of managing the information on the release of restriction of the present invention, the release information of the function selected by the system having a plurality of functions is moved to one identification information storage section and is edited there, and the release information is placed under collective management. Thus, the user using the system can utilize the system without sacrificing the work efficiency, even when the connection of the identification information storage section is limited.

Further, both the release information stored in the identification information storage section on the source for movement and that stored in the identification information storage section on the destination for movement are read out, moved and edited. This arrangement ensures reliable movement and editing.

Since the addition, selection and switching of the function can be managed by the minimum number of the identification information storage sections, the apparatus variations can be increased.

After the setting information of the identification information storage section has been moved and edited, the identification information storage section having no release information is recovered, and the manufacturer adds new release information to it and puts it on the market. This arrangement allows the identification information storage section to be reused repeatedly and hence the cost is reduced, and resources can be saved.

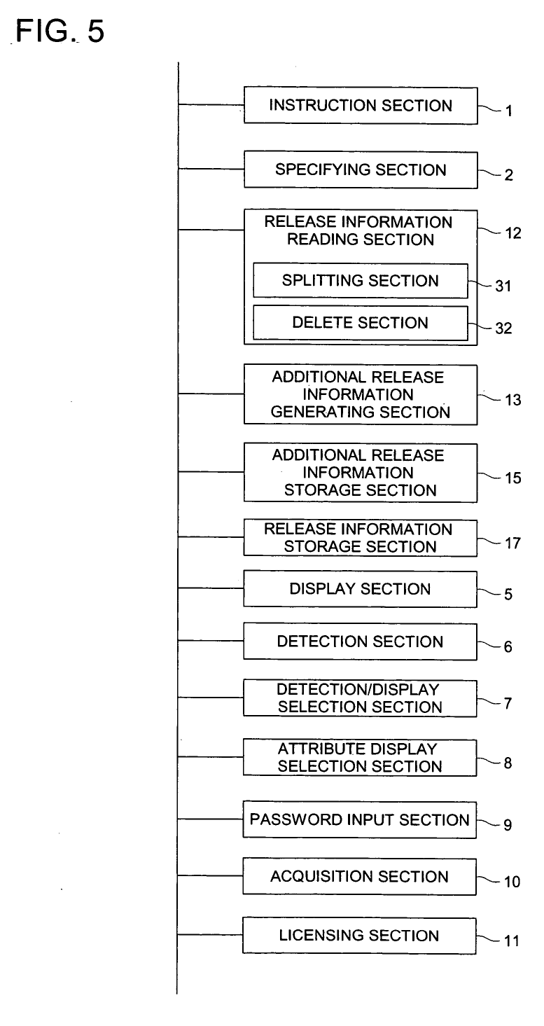

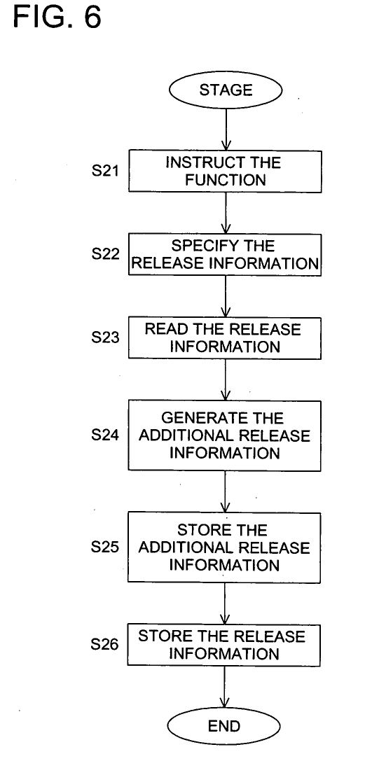

FIG. 5 is a functional block diagram representing a third embodiment of method of managing the information on the release of restriction on use according to the present invention. FIG. 6 is a processing flowchart representing an example of a method of managing the information on the release of restriction on use, as the third embodiment.

The present embodiment is basically the same as the second embodiment, the difference being that the delete release information generating section 14 and delete release information storage section 16 are not provided, and the release information is not deleted from the identification information storage section on the source for movement.

Referring to FIG. 6, the following describes the flow of processing: When the instruction for movement is given by the instruction section 1 (Step S21), the release information is specified by the specifying section 2 (Step S22).

The release information is read from the first and second identification information storage sections by the release information reading section 12 (Step S23), and additional release information is generated from the read release information by the additional release information generating section 13 (Step S24). The generated additional release information is stored into the second identification information storage section by the additional release information storage section 15 (Step S25). In the meantime, the release information of the first identification information storage section read by the release information reading section is stored in the first identification information storage section by a release information storage section 17 (Step S26).

As described above, in the method of managing the information on the release of restriction according to the present invention, the release information applied to the instruction for movement is deleted from the release information of the first identification information storage section, and the delete release information is generated and stored, in the case of the second embodiment. Instead of such arrangement, in the present third embodiment, the release information of the first identification information storage section having been read is directly stored.

According to the method of managing the information on the release of restriction of the present invention, the release information of the function selected by the system having a plurality of functions is moved to one identification information storage section and is edited there, and the release information is placed under collective management. Thus, the user using the system can utilize the system without sacrificing the work efficiency, even when the connection of the identification information storage section is limited.

Further, in the present embodiment, the release information stored in the identification information storage section on the source for movement remains undeleted. If the identification information storage section on the source from which information has been copied is placed under management of the service side, the release information having been moved and edited for a certain user can also be moved and edited for another user.

Since the addition, selection and switching of the function can be managed by the minimum number of the identification information storage sections, the apparatus variations can be increased.

After the setting information of the identification information storage section has been moved and edited, the identification information storage section having no release information is recovered, and the manufacturer adds new release information to it and puts it on the market. This arrangement allows the identification information storage section to be reused repeatedly and hence the cost is reduced, and resources can be saved.

Giving specific examples, the following describes the method of managing the information on the release of restriction according to the present invention:

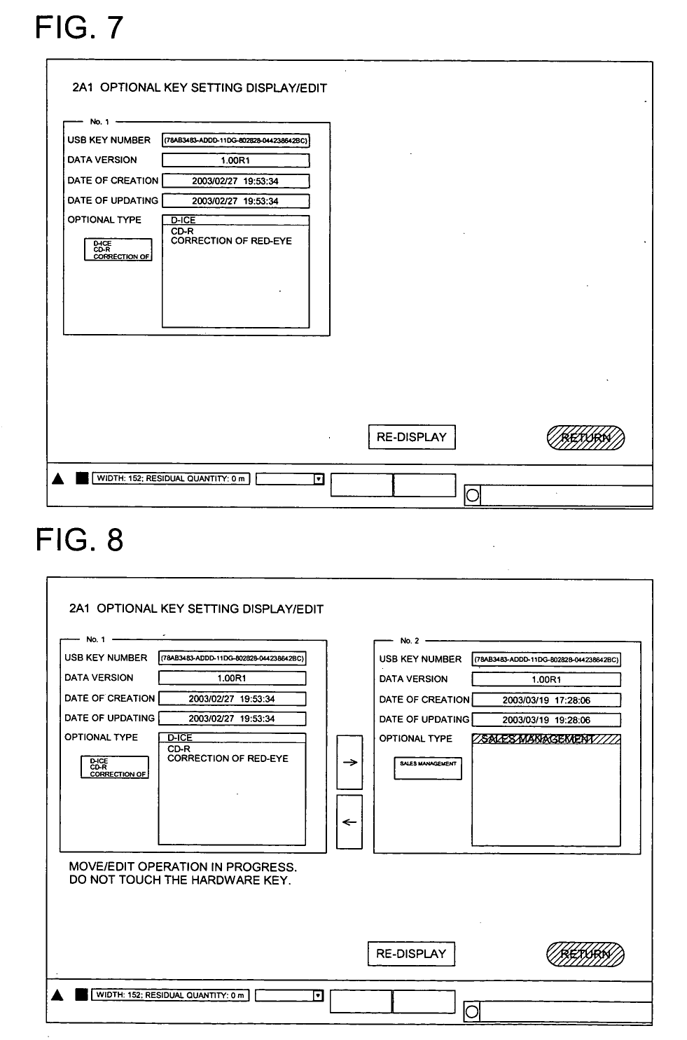

FIGS. 7 through 11 show the examples of displaying on the screen related to the processing of the method of managing the information on the release of restriction according to the present invention.

In the first place, when the hardware key is connected to the license management system, the screen shown in FIG. 7 appears. In FIG. 7, the connected hardware key is acquired and displayed.

If another hardware is connected to prompt re-display in this state, the screen shown in FIG. 8 appears. Two hardware keys connected are displayed.

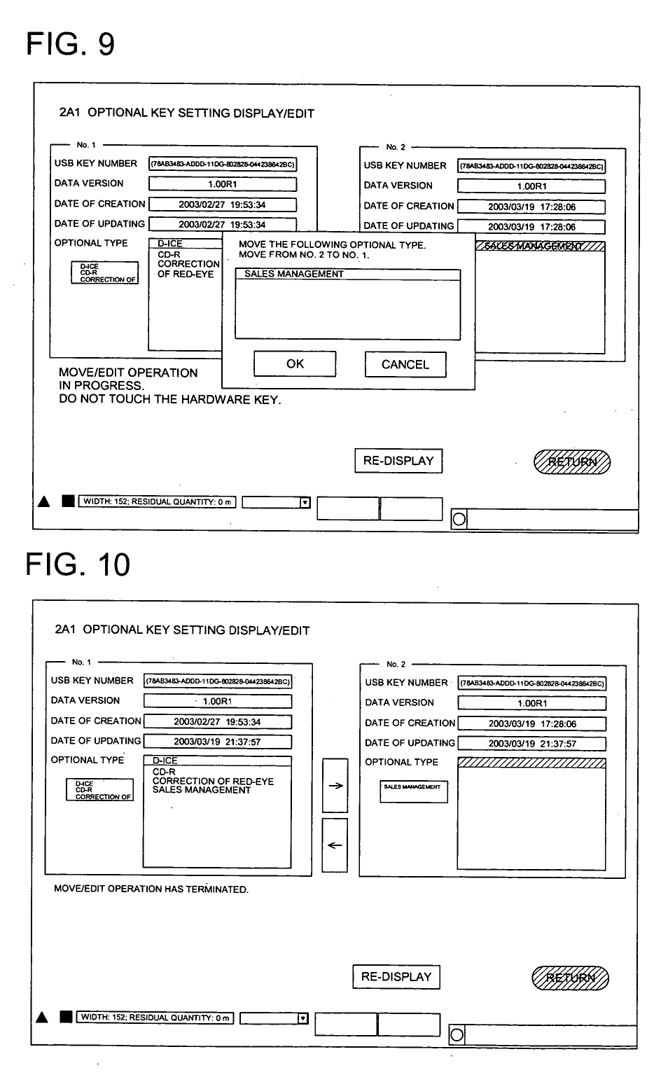

When a user has selected the function to be moved on the display screen given in FIG. 8 and has entered the input for determining the direction of movement, the popup window is displayed as shown in FIG. 9, so that the details of the input can be confirmed.

When a confirmation input is entered on the popup window, the selection function is deleted from the display of the function of the hardware key on the source from which the information has been moved, as shown in FIG. 10. It is then added to the hardware key on the destination, and is displayed. In this case, the release information is stored in the hardware key of the destination and is deleted from the hardware key on the source for movement.

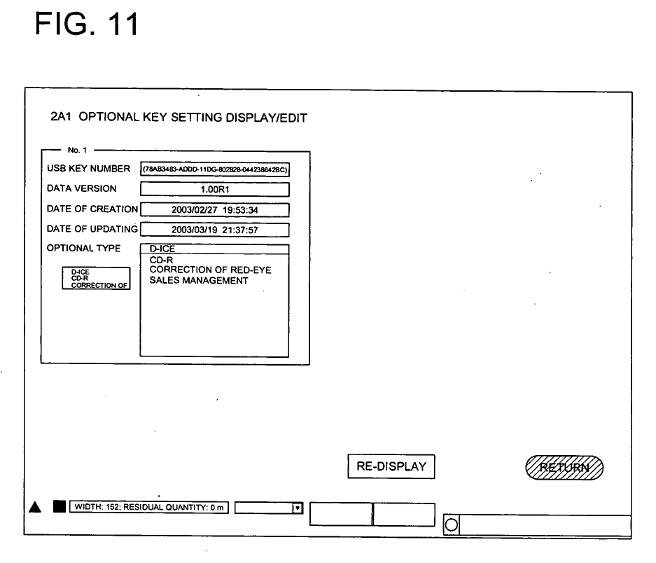

Upon completion of the aforementioned processing, the hardware key is removed from the license management system. Then the display of the function of the removed hardware key disappears, as shown in FIG. 11.

The following describes a third embodiment of the present invention with reference to drawings:

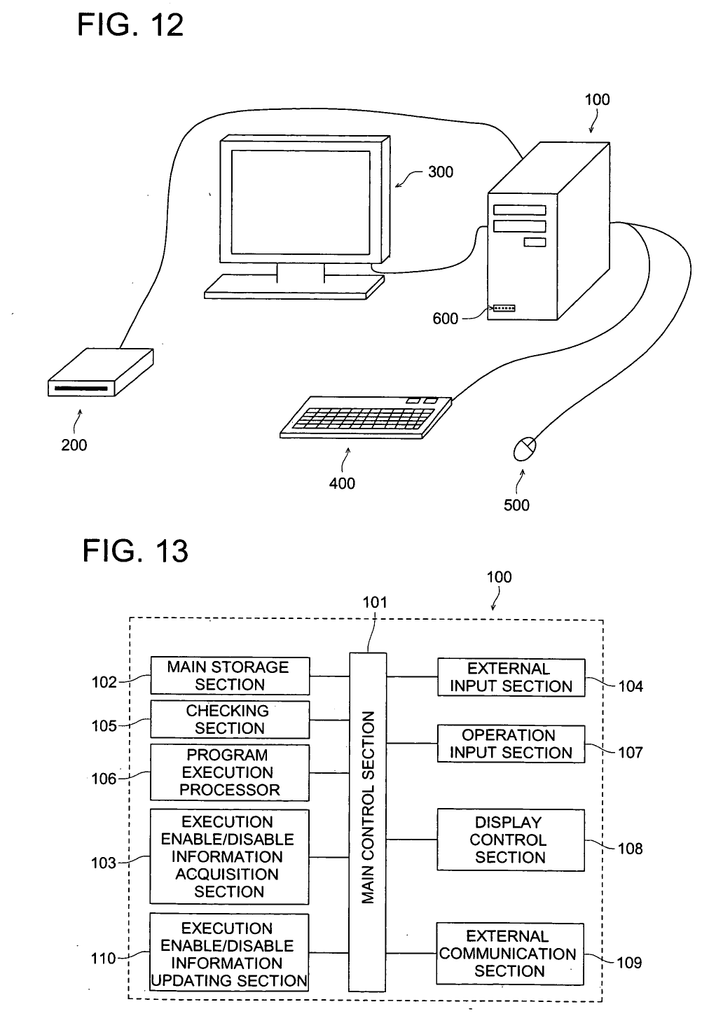

FIG. 12 is a diagram representing the schematic configuration of the license management system for implementing the license management method of the present invention.

In FIG. 12, the license management system of the present invention consists of a computer 100 for various types of processing, a CD-ROM drive 200 for as a recording medium reading means for reading a program from a recording medium such as a CD-ROM with a program recorded thereon, a monitor 300 as a display means for showing various displays, a keyboard 400 for entering various inputs, a mouse 500 and a USB port 600.

When the program for implementing the processing of the present invention has been installed, the computer 100 applies various types of processing by controlling the scanner 200, monitor 300, keyboard 400 and mouse 500.

The CD-ROM drive 200 reads a program from such a recording medium as a CD-ROM for recording the program as an object of the license management. The program is read under the control of the computer 100. The read program is sent to the computer 100.

The monitor 300 provides a display to prompt operation inputting or displays required to run the program. The monitor 300 is capable of acquiring the function of a touch panel as required, to serve as an input device.

The keyboard 400 and mouse 500 are used by the user, as required, to enter inputs in the processing of program storage to store a program, processing of execution enable/disable information acquisition for acquiring execution enable/disable information, and processing of checking to see if the program can be executed.

The USB port 600 is used as an interface for acquiring the execution enable/disable information from the recording medium with execution enable/disable information recorded thereon, when the execution enable/disable information is acquired from the recording medium with execution enable/disable information recorded thereon.

Further, in the license management system of the present invention, it is preferred that the computer 100 be capable of exchanging data with such an external apparatus as a server through a communication means (not illustrated). Either wired or wireless means can be used as the communication means. It can be the Internet, LAN, special-purpose communication line or any other form of communication means.

FIG. 13 is a block diagram representing a computer 100 used in the license management system.

The computer 100 comprises a main control section 101 for controlling each portion of the license management system, a main storage section 102 for loading the program and storing other various types of data, an execution enable/disable information acquisition/processing section 103 for acquiring execution enable/disable information, an external input section 104, for inputting various types of data acquired from a recording medium, including various external interfaces such as a CD-ROM drive 200 and USB port 600, a checking section 105 for checking whether or not the program can be executed, a program execution processor 106 for executing a program, an operation input section 107 for receiving operation input, a display control section 108 for controlling such a display means as monitor 300, an external communication section 109 for exchanging data with such an external as a server through the communication line.

In the license management system of the present invention, the computer 100 is preferred to have an execution enable/disable information updating section 110 for updating the execution enable/disable information.

The execution enable/disable information of the present invention is recorded in advance on the recording medium that can be linked with the USB port, or on such an external device as a server connected through the communication line.

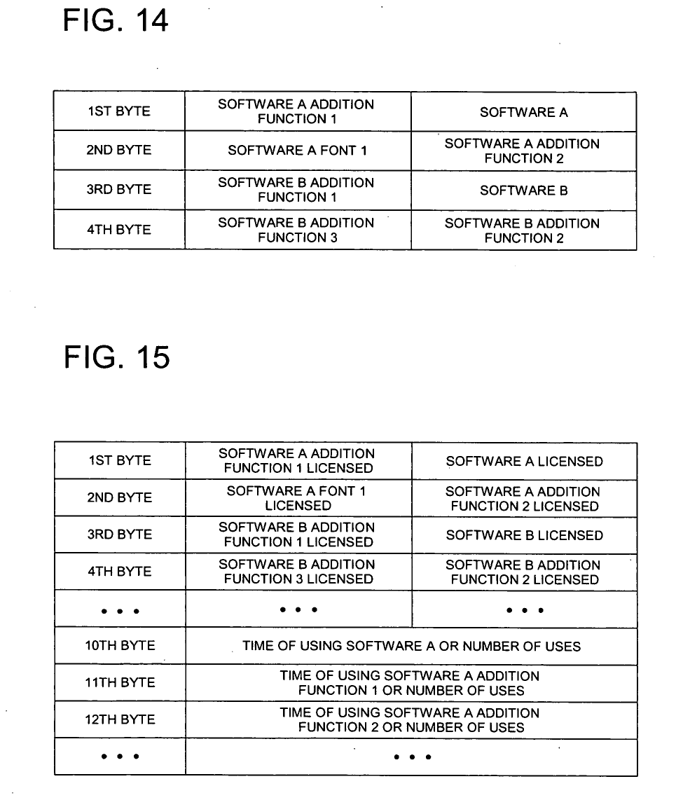

FIG. 14 is a diagram showing an example of recording execution enable/disable information in the present invention. FIG. 15 is a diagram showing another example of recording execution enable/disable information in the present invention.

In FIG. 14, the first through fourth bits of the first byte record the execution enable/disable information on the additional function 1 of the software A, and the fifth through eighth bits record the execution enable/disable information of the software A. Similarly, the first through fourth bits of the second byte record the execution enable/disable information on the font 1 of the software A, and the fifth through eighth bits record the execution enable/disable information on the additional function 2 of the software A. For the third byte, the first through fourth bits record the execution enable/disable information on the additional function 1 of the software A, and the fifth through eighth bits record the execution enable/disable information of the software A. For the fourth byte, the first through fourth bits record the execution enable/disable information on the additional function 3 of the software B, and the fifth through eighth bits record the additional function 2 of the software B.

As described above, four bits are assigned in such a license unit as one software function or one font for recording. Thus, if the 32-byte recording area can be ensured, a maximum of 64 types of software programs can be placed under license management. The information recorded on four bits can be assigned with meanings, for example, as follows: “0” is assigned to mean “Disabled”, and “1” to mean “Enabled”.

It is preferred that the execution enable/disable information contain the information on available time or available number of uses. FIG. 15 gives an example of the execution enable/disable information in this case.

In the example of FIG. 15, 10th byte records the information on the time of use indicating the time available to use the software A or the number of uses showing the available time. The 11th byte denotes the time of using the additional function 1 of software A or the number of uses. The 12th byte denotes the time of using the additional function 2 of software A or the number of uses.

For the information on the time of use or number of uses, as described above, information from 0 through 255 time unit in terms of time or from 0 through 255 uses in terms of the number of uses can be managed if a one-byte recording area is secured. For example, if a 30-byte area can be ensured, a maximum of 20 programs can be placed under license management.

The execution enable/disable information described with reference to FIGS. 14 and 15 is stored in the recording medium that can be connected to the license management system of the present invention, whereby this medium can be used as a license management recording medium of the present invention. In this case, a preferably used recording medium includes a hardware key (recording medium, connected to the USB port, equipped with a read/write-ready memory), USB Flash Memory, Smart Media (registered trademark), Compact Flash (registered trademark), SD memory card (registered trademark), and a specific file inside the hard disk executed by the program under license management.

The following describes the details of the operation in processing the license management system of the present invention, using the license management system of the present invention:

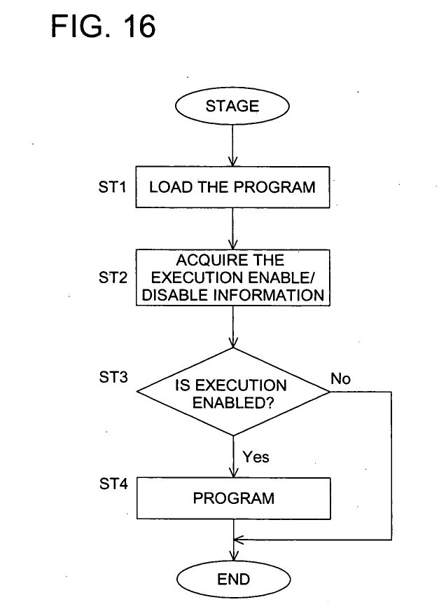

FIG. 16 is a diagram showing an example of the flow of processing in the license management method processed by the license management system of FIG. 12.

The program is loaded on the main storage section 102 (ST1).

Loading of the program is triggered by the reception of an instruction of loading (installing) the user's program from the input means such as the keyboard 400 or mouse 500.

The program can be loaded by acquiring the program stored in the server, through the communication line such as the Internet, or by reading such a recording medium as a CD-ROM with the program recorded thereon in advance, by means of the CD-ROM drive 200. The program acquired in this manner is stored in the main storage section 102.

In the license management system of the present invention, the program is installed where the program under the license management is stored in the main storage section 102. The execution of the program is subject to restriction until the license is granted (execution of the program is licensed).

Processing in Step S1 may be performed by the user after such hardware as the computer 100 has been purchased, or may be performed in advance, prior to the shipment of the hardware. When processing is performed by the user after hardware has been purchased, the user is allowed to select and store the program that may be employed. This arrangement is more effective since it eliminates the need of securing the area of the main storage section 102 for storing the unwanted program. If processing in Step S1 is performed in advance prior to the shipment of the hardware, the time and effort of the user to install the program can be eliminated, and this method is convenient in the case of the hardware that does not permit installation.

Then execution enable/disable information for the program under the license management is acquired (Step ST2).

Execution enable/disable information can be obtained by acquiring the execution enable/disable information stored in the server or the like through the Internet and other communication line, or by scanning the recording medium with the execution enable/disable information recorded thereon in advance, using the USB port 600. The program obtained in this manner is stored in the main storage section 102.

The acquisition of execution enable/disable information is triggered by the reception of the instruction that the user's program under the license management will be executed by an input means such as the keyboard 400 or mouse 500, and by the evaluation of the main control section 101 determining that the recording medium with the execution enable/disable information recorded thereon has been connected to the USB port 600.

Based on the trigger for the acquisition of the execution enable/disable information, the execution enable/disable information acquisition/processing section 103 starts processing of acquiring the execution enable/disable information. To put it more specifically, when the information is to be obtained via the communication line, based on the trigger, the execution enable/disable information acquisition/processing section 103 requests the server (not illustrated) via the external communication section 109 to get the execution enable/disable information, and starts processing of acquiring the execution enable/disable information sent in response to this request for acquisition, through the external communication section 109. Further, when the execution enable/disable information recorded on the recording medium is acquired, based on the trigger, the execution enable/disable information acquisition/processing section 103 acquires the execution enable/disable information recorded on the recording medium via the interface such as the USB port 600, and starts processing of acquiring the acquired execution enable/disable information through the external input section 104.

When the execution enable/disable information has been obtained through processing in Step S3, evaluation is made to see whether or not the program can be run (Step ST3), based on the execution enable/disable information acquired in this manner.

Processing of this evaluation is carried out by the checking section 105. The evaluation as to whether or not the program can be run is performed according to the execution enable/disable information acquired in Step ST2. If the execution enable/disable information contains the information indicating the available time, evaluation can be made depending on whether or not the available time is over the specified level. If the execution enable/disable information contains the information indicating the available time of use, evaluation can be made depending on whether or not the time of use is other than “0”.

If the evaluation is made in Step ST3 to determine that the program can be run, processing of running the program starts (Step ST4).

The program execution processor 106 starts the processing of running the program under the license management stored in the main storage section 102.

If it has been determined in Step S3 that the program cannot be run, the system terminates without running the program. In this case, it is preferred that the display control section 108 notify the user that the program is not licensed, for example, by giving the following warning message on the display means of the monitor 300 or the like: “This program is not licensed”. This arrangement notifies the user that the program cannot be run because it is not licensed. This will prompt the user to take action to get a new license.

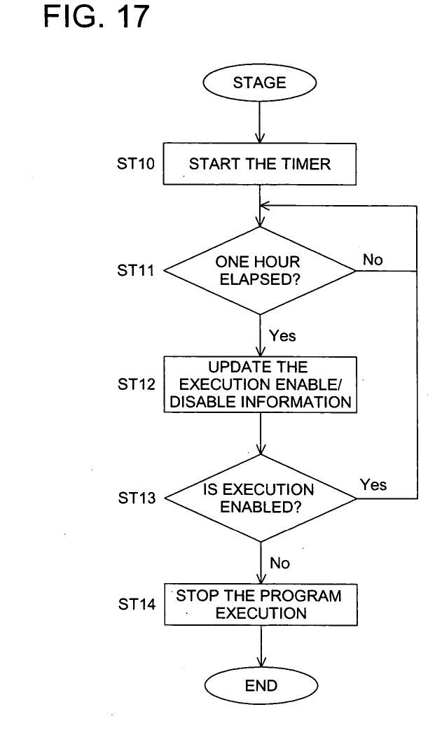

FIG. 17 is a diagram showing an example of the flow of processing when the license is updated in the license management method to be processed by the license management system of FIG. 12.

If processing of Step ST4 in the aforementioned flow, namely, the execution of the program is performed, the timer will start (Step ST10) on the assumption that the program execution has started.

Time is counted by the main control section 101, whereby the timer operates. Counting of time may be performed, for example, by using the clock mechanism located inside the CPU.

Then evaluating is made to check whether or not one hour has passed since the start of the timer (Step ST11).

The main control section 101 can be used for the evaluation in Step ST11. The aforementioned explanation is based on the case where the passage of time is evaluated based on the time period of one hour. However, the time period as the criterion for evaluation can be determined as desired.

Processing in Step ST11 continues until the lapse of one hour (as the standard time) is determined.

When the lapse of one hour (as the standard time) has been determined in Step Sil, processing of updating the execution enable/disable information starts (Step ST12).

In the processing of updating the execution enable/disable information, the execution enable/disable information updating section 110 generates the updated execution enable/disable information, based on the execution enable/disable information acquired in the aforementioned manner, and at the same time, sends the generated execution enable/disable information to the party having acquired the information.

When the execution enable/disable information includes the information on the available time, the time counted by the timer is subtracted from the available time. The execution enable/disable information is replaced by the subtracted time, whereby the updated execution enable/disable information is created.

When the execution enable/disable information includes the information on the available number of uses, one available number of uses is subtracted, and the execution enable/disable information is replaced by the resulting number of uses, whereby the updated execution enable/disable information is created.

Then based on the updated execution enable/disable information, evaluation is made to determine if the program can be executed or not (Step ST13).

Based on the updated execution enable/disable information, the evaluation in Step ST13 is performed in the same manner as that in the processing in Step ST3.

When it has been determined in Step ST13 that the program can be executed, the system goes back to Step ST11.

When it has been determined in Step ST13 that the program cannot be executed, execution of the program is suspended (Step ST14).

When execution of the program is suspended, processing of running the program by the program execution processor 106 can be stopped immediately. However, it is preferred that a warning message—“The license of your program has expired.”—be indicated on the display means such as the monitor 300 by the display control section 108. After the user has been notified of the expiration, the execution of the program should be stopped.

The present invention provides a license management system, a license management method and a license management recording medium that ensure a correct license management, without the trouble of software being disabled although the license has already been granted.

Disclosed embodiment can be varied by a skilled person without departing from the spirit and scope of the invention.

1. A method for controlling a release information set for releasing a function, which is one of a plurality of functions provided in an apparatus, from an application disabled status thereof, comprising the steps of:
instructing an operation for transferring said release information set from a first storage section, in which release information sets corresponding to said plurality of functions are stored, to a second storage section by selecting one of said plurality of functions provided in said apparatus;
specifying said release information set to be transferred as instructed in said instructing step;
reading out said release information set, specified in said specifying step, from said first storage section;
storing said release information set, read in said reading step, in said second storage section.

2. The method of claim 1, further comprising the step of;
displaying said function, being one of said plurality of functions provided in said apparatus, on a display section, so that said operation for transferring said release information set from said first storage section to said second storage section can be instructed by using said display device in said instructing step.

3. The method of claim 1,
wherein said reading step includes the step of:
dividing said release information set into divided release information sets; and
reading out said divided release information sets.

4. The method of claim 1,
wherein said reading step includes the step of:
deleting said release information set from a storage section from which said release information set was previously read.

5. The method of claim 1,
wherein, in said specifying step, another release information set for releasing another function, which interlocks said function selected in said instructing step, is also specified as a function to be transferred as instructed in said instructing step.

6. The method of claim 2, further comprising the steps of:
detecting any one of said first storage section, said second storage section and another storage section; and
determining whether or not a function, with respect to a release information set stored in a storage section detected in said detecting step, is displayed on said display section.

7. The method of claim 2, further comprising the step of:
determining whether or not at least one of creating dates of said first storage section, said second storage section and another storage section, serial numbers thereof, a version number of said function and a transferred/edited date of said release information, is displayed on said display section in addition to said function.

8. The method of claim 1, further comprising the step of:
inputting a first password owned by a user;
acquiring a second password allotted to a hardware-key; and
allowing said hardware-key to conduct a readout operation to be performed in said reading step, only when said first password coincides with said second password.

9. The method of claim 1,
wherein a hardware-key is employed as said first storage section and/or said second storage section.

10. A method for controlling a release information set for releasing a function, which is one of a plurality of functions provided in an apparatus, from an application disabled status thereof, comprising the steps of:
instructing an operation for transferring said release information set from a first storage section, in which release information sets corresponding to said plurality of functions are stored, to a second storage section by selecting one of said plurality of functions provided in said apparatus;
specifying said release information set to be transferred as instructed in said instructing step;
reading out a first release-information set and a second release-information set from said first storage section and said second storage section, respectively;
generating an added release-information set by adding said release-information set, specified in said specifying step, to said second release-information set read from said second storage section;
generating a deleted release-information set by deleting said release-information set, specified in said specifying step, from said first release-information set;
storing said added release-information set, generated in said first generating step, in said second storage section; and
storing said deleted release-information set, generated in said second generating step, in said first storage section.

11. The method of claim 10, further comprising the step of;
displaying said function, being one of said plurality of functions provided in said apparatus, on a display section, so that said operation for transferring said release information set from said first storage section to said second storage section can be instructed by using said display device in said instructing step.

12. The method of claim 10,
wherein said reading step includes the step of:
dividing said release information set into divided release information sets; and
reading out said divided release information sets.

13. The method of claim 10,
wherein said reading step includes the step of:
deleting said release information set from a storage section from which said release information set was previously read.

14. The method of claim 13,
wherein said step of storing said added release-information set and said step of storing said deleted release-information set are performed after said step of deleting said release information set is completed.

15. The method of claim 10,
wherein, in said specifying step, another release information set for releasing another function, which interlocks said function selected in said instructing step, is also specified as a function to be transferred as instructed in said instructing step.

16. The method of claim 11, further comprising the steps of:
detecting any one of said first storage section, said second storage section and another storage section; and
determining whether or not a function, with respect to a release information set stored in a storage section detected in said detecting step, is displayed on said display section.

17. The method of claim 11, further comprising the step of:
determining whether or not at least one of creating dates of said first storage section, said second storage section and another storage section, serial numbers thereof, a version number of said function and a transferred/edited date of said release information, is displayed on said display section in addition to said function.

18. The method of claim 10, further comprising the step of:
inputting a first password owned by a user;
acquiring a second password allotted to a hardware-key; and
allowing said hardware-key to conduct a readout operation to be performed in said reading step, only when said first password coincides with said second password.

19. The method of claim 10,
wherein a hardware-key is employed as said first storage section and/or said second storage section.

20. A method for controlling a release information set for releasing a function, which is one of a plurality of functions provided in an apparatus, from an application disabled status thereof, comprising the steps of:
instructing an operation for transferring said release information set from a first storage section, in which release information sets corresponding to said plurality of functions are stored, to a second storage section by selecting one of said plurality of functions provided in said apparatus;
specifying said release information set to be transferred as instructed in said instructing step;
reading out a first release-information set and a second release-information set from said first storage section and said second storage section, respectively;
generating an added release-information set by adding said release-information set, specified in said specifying step, to said second release-information set read from said second storage section;
generating a deleted release-information set by deleting said release-information set, specified in said specifying step, from said first release-information set;
storing said added release-information set, generated in said first generating step, in said second storage section; and
storing said first release-information set, read in said reading step, in said first storage section.

21. The method of claim 20, further comprising the step of;
displaying said function, being one of said plurality of functions provided in said apparatus, on a display section, so that said operation for transferring said release information set from said first storage section to said second storage section can be instructed by using said display device in said instructing step.

22. The method of claim 20,
wherein said reading step includes the step of:
dividing said release information set into divided release information sets; and
reading out said divided release information sets.

23. The method of claim 20,
wherein said reading step includes the step of:
deleting said release information set from a storage section from which said release information set was previously read.

24. The method of claim 23,
wherein said step of storing said added release-information set and said step of storing said deleted release-information set are performed after said step of deleting said release information set is completed.

25. The method of claim 20,
wherein, in said specifying step, another release information set for releasing another function, which interlocks said function selected in said instructing step, is also specified as a function to be transferred as instructed in said instructing step.

26. The method of claim 21, further comprising the steps of:
detecting any one of said first storage section, said second storage section and another storage section; and
determining whether or not a function, with respect to a release information set stored in a storage section detected in said detecting step, is displayed on said display section.

27. The method of claim 21, further comprising the step of:
determining whether or not at least one of creating dates of said first storage section, said second storage section and another storage section, serial numbers thereof, a version number of said function and a transferred/edited date of said release information, is displayed on said display section in addition to said function.

28. The method of claim 20, further comprising the step of:
inputting a first password owned by a user;
acquiring a second password allotted to a hardware-key; and
allowing said hardware-key to conduct a readout operation to be performed in said reading step, only when said first password coincides with said second password.

29. The method of claim 20,
wherein a hardware-key is employed as said first storage section and/or said second storage section.

30. A system for controlling a licensing operation of a program, comprising:
a program storing section to store said program;
a license-information acquiring section to acquire license information, which represent an enabled or disabled status in respect to an execution of said program;
a determining section to determine whether or not said program is allowed to execute, based on said license information acquired by said license-information acquiring section; and
a program executing section to execute said program only when said determining section determines that said program is allowed to execute.

31. The system of claim 30,
wherein said license information includes usable time information, and said determining section determines that said program is allowed to execute, when a usable time period represented by said usable time information exceeds a prescribed time period.

32. The system of claim 30,
wherein said license information includes usable number information, which represent a usable number of times of executing said program, and said determining section determines that said program is allowed to execute, when said usable number of times represented by said usable number is other than zero.

33. The system of claim 30, further comprising:
a license-information changing section to change a content of said license information.

34. The system of claim 33,
wherein said license-information changing section changes usable time information included in said license information before said determining section determines whether or not said program is allowed to execute.

35. The system of claim 33,
wherein said license-information changing section changes usable number information, which represent a usable number of times of executing said program and are included in said license information, before said determining section determines whether or not said program is allowed to execute.

36. The system of claim 30,
wherein said license-information acquiring section acquires said license information by reading said license information stored in a storage medium.

37. The system of claim 30,
wherein said license-information acquiring section acquires said license information through a communication line.

38. A method for controlling a licensing operation of a program, comprising the steps of:
storing said program in a program storing section;
acquiring license information, which represent an enabled or disabled status in respect to an execution of said program;
determining whether or not said program is allowed to execute, based on said license information acquired in said acquiring step;
executing said program only when it is determined in said determining step that said program is allowed to execute.

39. The method of claim 38,
wherein said license information includes usable time information, and it is determined in said determining step that said program is allowed to execute, when a usable time period represented by said usable time information exceeds a prescribed time period.

40. The method of claim 38,
wherein said license information includes usable number information, which represent a usable number of times of executing said program, and it is determined in said determining step that said program is allowed to execute, when said usable number of times represented by said usable number is other than zero.

41. The method of claim 38, further comprising the step of:
changing a content of said license information.

42. The method of claim 41,
wherein usable time information included in said license information are changed before it is determined in said determining step whether or not said program is allowed to execute.

43. The method of claim 41,
wherein usable number information, which represent a usable number of times of executing said program and are included in said license information, are changed before said determining section determines whether or not said program is allowed to execute.

44. The method of claim 38,
wherein said license information are acquired by reading said license information stored in a storage medium.

45. The method of claim 38,
wherein said license information are acquired through a communication line.

46. A storage medium linkable to a system for controlling a licensing operation of a program, comprising:
license information, which represent an enabled or disabled status in respect to an execution of said program;
wherein said system includes:
a program storing section to store said program;
a license-information acquiring section to acquire said license information, which represent an enabled or disabled status in respect to an execution of said program;
a determining section to determine whether or not said program is allowed to execute, based on said license information acquired by said license-information acquiring section; and
a program executing section to execute said program only when said determining section determines that said program is allowed to execute.
